(19) United States
(12) Patent Application Publication
(10) Pub. No.: US 2025/0230534 A1
(43) Pub. Date: Jul. 17, 2025

(54) SOFT MAGNETIC IRON

(71) Applicant: JFE STEEL CORPORATION, Chiyoda-ku, Tokyo (JP)

(72) Inventors: Michitoshi SAEKI, Chiyoda-ku, Tokyo (JP); Yuta IMANAMI, Chiyoda-ku, Tokyo (JP)

(73) Assignee: JFE STEEL CORPORATION, Chiyoda-ku, Tokyo (JP)

(21) Appl. No.: 18/854,062

(22) PCT Filed: Dec. 22, 2022
(86) PCT No.: PCT/JP2022/047464

§ 371 Date: Oct. 4, 2024

(30) Foreign Application Priority Data
Apr. 28, 2022 (JP) 2022-075424

(51) Int. Cl. C22C 38/60; C22C 38/00; C22C 38/02; C22C 38/04; C22C 38/06; C22C 38/08; C22C 38/12; C22C 38/14; C22C 38/16; C22C 38/22; C22C 38/28; C22C 38/32; H01F 1/147

(52) U.S. Cl. CPC C22C 38/60; C22C 38/001; C22C 38/002; C22C 38/008; C22C 38/02; C22C 38/04; C22C 38/06; C22C 38/08; C22C 38/12; C22C 38/14; C22C 38/16; C22C 38/22; C22C 38/28; C22C 38/32; H01F 1/147; C22C 2202/02

(57) ABSTRACT

A soft magnetic iron comprises a chemical composition containing, in mass %, C: 0.02% or less, Si: 0.05% or less, Mn: 0.010% to 0.500%, P: 0.002% to 0.020%, S: 0.001% to 0.050%, Al: 0.010% to 0.050%, O: 0.0010% to 0.0200%, N: 0.0010% to 0.0100%, and B: 0.0003% to 0.0065%, with a balance consisting of iron and inevitable impurities, wherein a total number density of precipitates of MnS, BN, and a composite compound thereof (MnS+BN) is 5,000/mm² or more, and in a frequency distribution of equivalent circular diameters of the precipitates observed in a region of 0.2 mm² or more, a mode is 50 nm or more and 250 nm or less and a proportion of precipitates of 600 nm or more in equivalent circular diameter is 7% or more.

### TECHNICAL FIELD

The present disclosure relates to a soft magnetic iron.

### BACKGROUND

Resource and energy saving is needed worldwide for global environment protection in recent years. In the field of electrical machinery, efficiency enhancement and downsizing are actively promoted with the aim of saving energy. Hence, electrical parts used in automobiles and the like are required to be more power-saving and be improved in the response speed to external magnetic fields.

Pure iron-based soft magnetic iron is typically used as material that easily responds to external magnetic fields. For such soft magnetic iron, a steel material having a C content of approximately 0.01 mass % or less is used. Usually, the steel material is hot rolled and then subjected to wiredrawing and the like to obtain a steel bar, and the steel bar is subjected to forging, cutting work, and the like to produce electrical parts.

It is known that, in parts machining, soft ferrite single phase contained in soft magnetic iron has very poor workability of cutting. This makes it increasingly important to provide soft magnetic iron excellent in not only magnetic properties but also workability, in particular, machinability by cutting and cold workability.

For example, JP 2007-51343 A (PTL 1) discloses a technique of producing a soft magnetic steel material excellent in magnetic properties and machinability by cutting by controlling the size and number of MnS precipitates dispersed in steel.

JP 2007-46125 A (PTL 2) discloses a technique for a soft magnetic steel material excellent in cold forgeability, machinability by cutting, and magnetic properties by controlling the size and density of FeS precipitates.

### CITATION LIST

### Patent Literature

PTL 1: JP 2007-51343 A
PTL 2: JP 2007-46125 A

### SUMMARY

### Technical Problem

The techniques described in PTL 1 and PTL 2 each improve machinability by cutting by the solitary effect of MnS or FeS. However, increasing such precipitates (MnS or FeS) is likely to cause degradation in magnetic properties. There is thus a technical limit to achieving both magnetic properties and workability at a higher level.

It could therefore be helpful to provide a steel material that is excellent in cold workability and has both magnetic properties and machinability by cutting at a high level.

### Solution to Problem

Upon careful examination, we newly discovered that, by employing the following structure of newly utilizing BN in addition to the solitary effect of MnS or the like conventionally used, machinability by cutting and cold workability can be improved while maintaining good magnetic properties.

The present disclosure is based on these new discoveries and further studies. We thus provide the following.
[1] A soft magnetic iron comprising a chemical composition containing (consisting of), in mass %, C: 0.02% or less, Si: 0.05% or less, Mn: 0.010% or more and 0.500% or less, P: 0.002% or more and 0.020% or less, S: 0.001% or more and 0.050% or less, Al: 0.010% or more and 0.050% or less, O: 0.0010% or more and 0.0200% or less, N: 0.0010% or more and 0.0100% or less, and B: 0.0003% or more and 0.0065% or less, with a balance consisting of iron and inevitable impurities, wherein a total number density of precipitates of manganese sulfide (MnS), boron nitride (BN), and a composite compound thereof (MnS+BN) is 5,000/mm² or more, and in a frequency distribution of equivalent circular diameters of the precipitates observed in a region of 0.2 mm² or more, a mode is 50 nm or more and 250 nm or less and a proportion of precipitates of 600 nm or more in equivalent circular diameter is 7% or more.
[2] The soft magnetic iron according to [1], wherein the chemical composition further contains, in mass %, one or more selected from Cu: 0.20% or less, Ni: 0.30% or less, and Cr: 0.30% or less.
[3] The soft magnetic iron according to [1] or [2], wherein the chemical composition further contains, in mass %, one or more selected from Mo: 0.10% or less, V: 0.02% or less, Nb: 0.015% or less, and Ti: 0.010% or less.
[4] The soft magnetic iron according to [1] or [2], wherein the chemical composition further contains, in mass %, one or two selected from Sn: 0.10% or less, and Sb: 0.10% or less.
[5] The soft magnetic iron according to [3], wherein the chemical composition further contains, in mass %, one or two selected from Sn: 0.10% or less, and Sb: 0.10% or less.

### Advantageous Effect

It is thus possible to provide a soft magnetic iron as a steel material that is excellent in cold workability and has both magnetic properties and machinability by cutting at a high level.

### DETAILED DESCRIPTION

A soft magnetic iron according to an embodiment of the present disclosure (hereafter also referred to as “soft magnetic iron according to this embodiment) will be described below.

The foregoing conventional technique of dispersing a compound such as MnS in a steel material was found to have the following problem: As a result of increasing the amount of the compound, the compound itself may exert a pinning effect and hinder the growth of crystal grains (i.e. refines crystals) in the matrix phase of the steel material, thus degrading magnetic properties.

In order to solve this problem, we repeatedly conducted experiments under various production conditions and obtained various steel materials, and investigated the compound form in each of the obtained steel materials. As a result, it was found that, in a specific steel material, manganese sulfide (MnS), boron nitride (BN), and their composite compound (MnS+BN) precipitated as inclusions and the distribution of the equivalent circular diameters of these precipitates was non-uniform.

Then, in order to establish suitable conditions, each of the obtained steel materials was mirror polished, and thereafter, at a position near the surface layer of the steel material where decarburization and oxidation reactions had not occurred, the state of the compounds in a region of 0.2 mm² was analyzed using a scanning electron microscope (SEM) and an energy-dispersive X-ray spectrometer (EDS) attached to the SEM with 10000 magnification. As a result, it was found that magnetic properties, cold workability, and/or machinability by cutting was insufficient when the total number density of MnS, BN, and their composite compound (MnS+BN) precipitated in the steel material was less than 5,000/mm². Furthermore, upon determining the equivalent circular diameters of the precipitates of MnS, BN, and their composite compound (MnS+BN) and obtaining their frequency distribution, it was revealed that magnetic properties, cold workability, and machinability by cutting were well balanced when, in the obtained frequency distribution, the mode was in the range of 50 nm or more and 250 nm or less and the proportion (number proportion) of precipitates of 600 nm or more in equivalent circular diameter was 7% or more.

We consider these results as follows.

When the crystal grains in the steel material are coarser, the magnetic properties of the steel material are better. However, compounds such as MnS, which contribute to improved machinability by cutting, hinder the growth of crystal grains in the matrix phase due to the pinning effect and cause degradation in magnetic properties, as mentioned above. This pinning force is less likely to act uniformly in the steel material when variation in compound size is greater. Such non-uniformity of the pinning force leads to a mixture of coarse crystal grains and fine crystal grains (i.e. mixed grains). In this case, if the coarse crystal grains encroach on the fine crystal grains, abnormal grain growth tends to occur. This results in coarsening of the crystal grain size in the steel material. These coarse crystal grains, which can exhibit excellent magnetic properties, are obtained from the compounds that contribute to improved machinability by cutting. The steel material thus has excellent magnetic properties and machinability by cutting while maintaining good cold workability.

The present disclosure is based on these new discoveries and further studies. In the following description, the number density of certain precipitates, the mode in the frequency distribution of the equivalent circular diameters of the precipitates, and the proportion of precipitates of 600 nm or more in equivalent circular diameter in the frequency distribution mentioned above are also collectively referred to as the “distribution form of precipitates”.

Next, the reasons for limiting each basic component in the chemical composition of the soft magnetic iron according to this embodiment will be described. Herein, “%” representing the content of each component (element) denotes “mass %” unless otherwise stated.

The content of each component (element) can be measured by the method for spark discharge atomic emission spectrometric analysis, X-ray fluorescence analysis, ICP optical emission spectrometry, ICP mass spectrometry, combustion method, etc.

C: 0.02% or less

If the C content is more than 0.02%, magnetic properties degrade significantly due to magnetic aging. The C content is therefore 0.02% or less. From the same viewpoint, the C content is preferably 0.015% or less and more preferably 0.010% or less. If the C content is less than 0.001%, the effect on magnetic properties is saturated. Moreover, reducing the C content to less than 0.001% requires higher refining costs. Accordingly, the C content is preferably 0.001% or more.

Si: 0.05% or less

Si is an element effective as a deoxidizing element. If the Si content is more than 0.05%, ferrite hardens and cold workability decreases. The Si content is therefore 0.05% or less. From the same viewpoint, the Si content is preferably 0.03% or less. The Si content may be 0%. In order to achieve its effect as a deoxidizing element, however, the Si content is preferably 0.005% or more and more preferably 0.01% or more.

Mn: 0.010% or more and 0.500% or less

Mn is an element that is not only effective in strength improvement by solid solution strengthening but also effective in improvement of machinability by cutting as a result of MnS, which is formed by combination of Mn and S, dispersing in the steel. In order to achieve this effect, the Mn content is 0.010% or more. If the Mn content is excessively high, not only magnetic properties degrade but also the desired distribution form of precipitates cannot be obtained. The Mn content is therefore 0.500% or less. From the same viewpoint, the Mn content is preferably 0.050% or more and more preferably 0.150% or more. The Mn content is preferably 0.400% or less and more preferably 0.350% or less.

P: 0.002% or more and 0.020% or less

P is an element that exhibits considerable solid solution strengthening ability even when added in a relatively small amount. In order to achieve this effect, the P content is 0.002% or more. If the P content is excessively high, cold workability decreases. The P content is therefore 0.020% or less. From the same viewpoint, the P content is preferably 0.015% or less.

S: 0.001% or more and 0.050% or less

S forms MnS in the steel to contribute to improved machinability by cutting. In order to sufficiently improve machinability by cutting and also obtain the desired distribution form of precipitates, the S content is 0.001% or more. If the S content is more than 0.050%, not only cold workability decreases but also the compound coarsens and the desired distribution form of precipitates cannot be obtained. The S content is therefore 0.050% or less. From the same viewpoint, the S content is preferably 0.005% or more and more preferably 0.010% or more. The S content is preferably 0.045% or less and more preferably 0.040% or less.

Al: 0.010% or more and 0.050% or less

Al is an element effective as a deoxidizing material. If the Al content is 0.010% or more, the amount of oxygen in the molten steel can be reduced to reduce harmful oxides and improve the yield rate of alloying elements. If the Al content is more than 0.050%, workability and magnetic properties degrade due to an increase of Al oxides. The Al content is therefore 0.010% or more and 0.050% or less. From the same viewpoint, the Al content is preferably 0.045% or less and more preferably 0.040% or less.

O: 0.0010% or more and 0.0200% or less

O has the effect of improving machinability by cutting by combining with sulfide inclusions and thereby coarsening the inclusions. In order to achieve this effect, the O content is 0.0010% or more. If the O content is excessively high, the toughness of the steel material decreases, causing early fracture of structural parts (components) using the steel material. The O content is therefore 0.0200% or less. From the same viewpoint, the O content is preferably more than 0.0010%. The O content is preferably 0.0190% or less and more preferably 0.0180% or less.

N: 0.0010% or more and 0.0100% or less

N combines with B in the steel material to form BN, thus contributing to improved machinability by cutting. In order to achieve this effect and also obtain the desired distribution form of precipitates, the N content needs to be 0.0010% or more. If the N content is more than 0.0100%, not only cold workability and/or magnetic properties degrade but also the compound coarsens and the desired distribution form of precipitates cannot be obtained. The N content is therefore 0.0100% or less. From the same viewpoint, the N content is preferably 0.0015% or more. The N content is preferably 0.0090% or less.

B: 0.0003% or more and 0.0065% or less

B combines with N in the steel material to form BN, thus contributing to improved machinability by cutting. In order to achieve this effect and also obtain the desired distribution form of precipitates, the B content needs to be 0.0003% or more. If the B content is more than 0.0065%, not only magnetic properties and/or castability degrades but also the compound coarsens and the desired distribution form of precipitates cannot be obtained. The B content is therefore 0.0065% or less. From the same viewpoint, the B content is preferably 0.0005% or more and more preferably 0.0010% or more. The B content is preferably 0.0060% or less and more preferably 0.0055% or less.

The basic components in the chemical composition of the soft magnetic iron have been described above.

The chemical composition of the soft magnetic iron may optionally further contain one or more of the following elements in addition to the above-described components:
Cu: 0.20% or less,
Ni: 0.30% or less, and
Cr: 0.30% or less.

Cu, Ni, and Cr contribute to higher strength mainly by solid solution strengthening. In order to achieve this effect, in the case of adding Cu, the Cu content is preferably 0.01% or more. Likewise, in the case of adding Ni, the Ni content is preferably 0.01% or more. Likewise, in the case of adding Cr, the Cr content is preferably 0.01% or more.

If the content of each of Cu, Ni, and Cr is excessively high, magnetic properties degrade. Accordingly, in the case of adding Cu, the Cu content is preferably 0.20% or less. Likewise, in the case of adding Ni, the Ni content is preferably 0.30% or less. Likewise, in the case of adding Cr, the Cr content is preferably 0.30% or less.

Moreover, the chemical composition of the soft magnetic iron may optionally further contain one or more of the following elements in addition to the above-described components:
Mo: 0.10% or less,
V: 0.02% or less,
Nb: 0.015% or less, and
Ti: 0.010% or less.

Mo, V, Nb, and Ti contribute to higher strength mainly by strengthening by precipitation. In order to achieve this effect, in the case of adding Mo, the Mo content is preferably 0.001% or more. Likewise, in the case of adding V, the V content is preferably 0.0001% or more. Likewise, in the case of adding Nb, the Nb content is preferably 0.0001% or more. Likewise, in the case of adding Ti, the Ti content is preferably 0.0001% or more.

If the content of each of Mo, V, Nb, and Ti is excessively high, magnetic properties and/or cold workability degrades. Accordingly, in the case of adding Mo, the Mo content is preferably 0.10% or less. Likewise, in the case of adding V, the V content is preferably 0.02% or less. Likewise, in the case of adding Nb, the Nb content is preferably 0.015% or less. Likewise, in the case of adding Ti, the Ti content is preferably 0.010% or less.

Moreover, the chemical composition of the soft magnetic iron may optionally further contain one or more of the following elements in addition to the above-described components:
Sn: 0.10% or less, and
Sb: 0.10% or less.

Sn and Sb have the effect of improving descalability in the processes of shot blasting and pickling performed before cold wiredrawing. In the case where the production of parts involves these processes, Sn and/or Sb may be optionally added. In order to achieve this effect, in the case of adding Sn, the Sn content is preferably 0.001% or more. Likewise, in the case of adding Sb, the Sb content is preferably 0.001% or more.

If the content of each of Sn and Sb is excessively high, not only the descalability improving effect is saturated but also magnetic properties degrade. Accordingly, in the case of adding Sn, the Sn content is preferably 0.10% or less. Likewise, in the case of adding Sb, the Sb content is preferably 0.10% or less.

The components (balance) other than the above in the chemical composition of the soft magnetic iron consist of iron (Fe) and inevitable impurities.

Next, the main characteristics, particularly the microstructure (distribution form of precipitates), of the soft magnetic iron according to this embodiment as a steel material will be described. In the present disclosure, it is important to quantitatively grasp the number density of specific precipitates in the steel material and the distribution of their diameters (equivalent circular diameters). The number density and the distribution are specified at a position near the surface layer of the steel material (soft magnetic iron) where decarburization and oxidation reactions have not occurred, namely, a stationary part.

MnS, BN, and their composite compound (MnS+BN) are inclusions that improve machinability by cutting. Dispersing them in the steel material at high density further enhances the effect of improving machinability by cutting. In the steel material (soft magnetic iron) according to this embodiment, the total number density of the dispersed precipitates of MnS, BN, and their composite compound (MnS+BN) needs to be 5,000/mm² or more. In order to achieve a number density of 5,000/mm² or more, compounds of 0.5 μm or less need to be present substantially. Hence, observation of an image with a relatively high magnification is required in order to determine the number density of the precipitates. For example, the number density of the precipitates can be determined by observing a region of 0.2 mm² or more using a scanning electron microscope (SEM). The number density may be 50,000/mm² or less, without being limited thereto.

Considering the detection limits of typical microscopes, the precipitates to be measured may typically be precipitates of 50 nm or more.

Moreover, in the steel material (soft magnetic iron) according to this embodiment, it is necessary that, in the frequency distribution of the equivalent circular diameters of the precipitates observed in the region of 0.2 mm² or more, the mode is 50 nm or more and 250 nm or less and the proportion of precipitates of 600 nm or more in equivalent circular diameter is 7% or more. The proportion of precipitates of 600 nm or more in equivalent circular diameter may be 40% or less, without being limited thereto. Such a frequency distribution in which the proportion of precipitates larger than the mode is equal to or greater than a certain value often has a shape close to bimodality. Here, the region of 0.2 mm² or more can be observed using a scanning

electron microscope (SEM), as with the number density. The precipitates observed may include precipitates made of components other than MnS, BN, and their composite compound (MnS+BN). The use of an energy-dispersive X-ray spectrometer (EDS) for analysis enables identifying precipitates of MnS, BN, and their composite compound (MnS+BN), which can then be the subject of the frequency distribution. The frequency distribution (e.g. histogram) of the equivalent circular diameters, from which the mode is to be determined, can be created with a class interval of equivalent circular diameters being set to 50 nm or less.

An example of the way of obtaining the desired distribution form of precipitates is to appropriately adjust especially Mn, S, Al, O, B, and N in the chemical composition so that the main oxides formed in the steel material will be Al-based oxides.

The soft magnetic iron according to this embodiment preferably has a critical upset ratio of 55% or more. If the critical upset ratio is 55% or more, better cold workability can be achieved.

The critical upset ratio is defined as the upset ratio when a test piece of 15 mm in diameter and 22.5 mm in height and having a notch with a depth of 0.8 mm and a notch bottom radius R 0.15 on its side surface, collected from a depth position corresponding to ½ of the diameter from the peripheral surface of the soft magnetic iron formed into a steel bar, is subjected to compression forming until a crack with a width of 0.5 mm or more occurs at the notch bottom of the test piece.

The soft magnetic iron according to this embodiment has excellent machinability by cutting, and therefore preferably has a shape of any of a bar (straight bar, steel bar, etc.) and a coil, which are mainly used in applications involving cutting work.

Next, a preferred method of producing the soft magnetic iron according to this embodiment will be described.

For example, molten steel having the above-described chemical composition is prepared by a smelting method using a typical converter, electric furnace, etc. and subjected to typical continuous casting or blooming to yield a steel material. The steel material is then optionally heated, and then subjected to hot rolling such as billet rolling or bar/wire rolling to obtain a soft magnetic iron. In particular, in the production method, it is preferable to set the thickness of the steel material or the diameter of the steel bar after the hot rolling to 10 mm or more and also it is preferable to allow it to naturally cool after the hot rolling, in order to obtain the desired distribution form of precipitates and thus improve cold workability, magnetic properties, and machinability by cutting. Moreover, in the production method, it is preferable not to perform annealing treatment in order to obtain the desired distribution form of precipitates and thus improve cold workability, magnetic properties, and machinability by cutting. Other conditions are not limited. For example, microstructure control may be performed so as to be advantageous for subsequent forging, machining, etc. for forming parts. Other production conditions may be in accordance with typical steel material production methods.

### EXAMPLES

The presently disclosed technique will be described in more detail below by way of examples. The present disclosure is, however, not limited to the examples below.

For each of steels No. 1 to 34, molten steel having the chemical

composition shown in Table 1 was obtained, and then heated to 1200° C. and subjected to hot rolling with a rolling finish temperature of 900° C. to produce a steel bar (soft magnetic iron) having a diameter of 25 mm. Thus, no annealing treatment was performed in the production of steels No. 1 to 34. For each of steels No. 35 and 36, molten steel having the chemical composition shown in Table 1 was obtained, then heated to 1200° C. and subjected to hot forging, and then subjected to intermediate annealing at 950° C. to obtain a steel bar (soft magnetic iron) having a diameter of 25 mm.

TABLE 1

| Steel | | | | | | | | | | |
|---|---|---|---|---|---|---|---|---|---|---|
| sample No. | C | Si | Mn | P | S | Al | O | N | B | Cu |
| 1 | 0.004 | 0.018 | 0.237 | 0.011 | 0.021 | 0.014 | 0.0012 | 0.0060 | 0.0016 | — |
| 2 | 0.005 | 0.015 | 0.217 | 0.005 | 0.007 | 0.020 | 0.0014 | 0.0070 | 0.0024 | 0.03 |
| 3 | 0.009 | 0.025 | 0.203 | 0.013 | 0.024 | 0.023 | 0.0020 | 0.0050 | 0.0015 | — |
| 4 | 0.002 | 0.011 | 0.202 | 0.007 | 0.020 | 0.021 | 0.0043 | 0.0050 | 0.0014 | — |
| 5 | 0.007 | 0.016 | 0.241 | 0.012 | 0.014 | 0.024 | 0.0052 | 0.0030 | 0.0018 | — |
| 6 | 0.007 | 0.018 | 0.226 | 0.008 | 0.012 | 0.022 | 0.0034 | 0.0040 | 0.0023 | — |
| 7 | 0.003 | 0.019 | 0.241 | 0.009 | 0.009 | 0.014 | 0.0059 | 0.0050 | 0.0010 | — |
| 8 | 0.005 | 0.026 | 0.324 | 0.007 | 0.011 | 0.024 | 0.0048 | 0.0060 | 0.0008 | — |
| 9 | 0.008 | 0.014 | 0.360 | 0.011 | 0.018 | 0.031 | 0.0042 | 0.0020 | 0.0012 | — |
| 10 | 0.007 | 0.010 | 0.215 | 0.003 | 0.022 | 0.032 | 0.0068 | 0.0060 | 0.0026 | — |
| 11 | 0.007 | 0.020 | 0.212 | 0.008 | 0.011 | 0.029 | 0.0071 | 0.0020 | 0.0027 | — |
| 12 | 0.009 | 0.019 | 0.143 | 0.011 | 0.018 | 0.021 | 0.0073 | 0.0070 | 0.0021 | 0.02 |
| 13 | 0.026 | 0.029 | 0.169 | 0.003 | 0.014 | 0.034 | 0.0012 | 0.0050 | 0.0034 | — |
| 14 | 0.004 | 0.310 | 0.118 | 0.005 | 0.018 | 0.036 | 0.0012 | 0.0060 | 0.0017 | 0.11 |
| 15 | 0.006 | 0.017 | 0.740 | 0.011 | 0.010 | 0.035 | 0.0012 | 0.0050 | 0.0024 | — |
| 16 | 0.003 | 0.014 | 0.181 | 0.032 | 0.019 | 0.033 | 0.0012 | 0.0030 | 0.0016 | — |
| 17 | 0.004 | 0.020 | 0.142 | 0.003 | 0.094 | 0.032 | 0.0012 | 0.0030 | 0.0015 | — |
| 18 | 0.006 | 0.014 | 0.198 | 0.009 | 0.012 | 0.067 | 0.0012 | 0.0020 | 0.0018 | — |
| 19 | 0.005 | 0.016 | 0.102 | 0.005 | 0.010 | 0.016 | 0.0250 | 0.0070 | 0.0026 | — |
| 20 | 0.009 | 0.024 | 0.131 | 0.009 | 0.012 | 0.034 | 0.0012 | 0.0140 | 0.0022 | — |
| 21 | 0.009 | 0.016 | 0.157 | 0.007 | 0.020 | 0.024 | 0.0012 | 0.0050 | 0.0116 | — |
| 22 | 0.002 | 0.020 | 0.159 | 0.009 | 0.017 | 0.016 | 0.0012 | 0.0020 | 0.0006 | 0.54 |
| 23 | 0.010 | 0.026 | 0.176 | 0.003 | 0.007 | 0.022 | 0.0012 | 0.0040 | 0.0023 | — |
| 24 | 0.007 | 0.029 | 0.130 | 0.012 | 0.022 | 0.021 | 0.0012 | 0.0060 | 0.0019 | — |
| 25 | 0.004 | 0.011 | 0.195 | 0.009 | 0.008 | 0.021 | 0.0012 | 0.0020 | 0.0021 | — |
| 26 | 0.005 | 0.026 | 0.179 | 0.004 | 0.021 | 0.019 | 0.0012 | 0.0020 | 0.0017 | — |
| 27 | 0.009 | 0.013 | 0.219 | 0.011 | 0.023 | 0.018 | 0.0012 | 0.0060 | 0.0015 | — |
| 28 | 0.002 | 0.018 | 0.220 | 0.006 | 0.020 | 0.015 | 0.0012 | 0.0030 | 0.0009 | 0.09 |
| 29 | 0.006 | 0.017 | 0.240 | 0.003 | 0.019 | 0.016 | 0.0012 | 0.0030 | 0.0026 | — |
| 30 | 0.007 | 0.020 | 0.217 | 0.005 | 0.010 | 0.021 | 0.0012 | 0.0060 | 0.0019 | — |
| 31 | 0.002 | 0.022 | 0.234 | 0.006 | 0.0004 | 0.014 | 0.0012 | 0.0050 | 0.0019 | — |
| 32 | 0.003 | 0.017 | 0.194 | 0.004 | 0.004 | 0.016 | 0.0012 | 0.0060 | 0.0001 | 0.04 |
| 33 | 0.018 | 0.028 | 0.008 | 0.005 | 0.021 | 0.018 | 0.0012 | 0.0050 | 0.0016 | — |
| 34 | 0.003 | 0.021 | 0.221 | 0.004 | 0.026 | 0.016 | 0.0012 | 0.0004 | 0.0015 | — |
| 35 | 0.007 | 0.018 | 0.226 | 0.008 | 0.020 | 0.022 | 0.0034 | 0.0040 | 0.0023 | — |
| 36 | 0.005 | 0.026 | 0.124 | 0.007 | 0.011 | 0.024 | 0.0048 | 0.0060 | 0.0008 | — |

| Steel | | | | | | | | | |
|---|---|---|---|---|---|---|---|---|---|
| sample No. | Ni | Cr | Mo | V | Nb | Ti | Sb | Sn | Remarks |
| 1 | — | — | — | — | — | — | — | — | |
| 2 | — | — | — | — | — | — | — | — | |
| 3 | 0.05 | — | — | — | — | — | — | — | |
| 4 | — | 0.04 | — | — | — | — | — | — | |
| 5 | — | — | 0.005 | — | — | — | — | — | |
| 6 | — | — | — | 0.0011 | — | — | — | — | |
| 7 | — | — | — | — | — | 0.0030 | — | — | |
| 8 | — | — | — | — | 0.0008 | — | — | — | |
| 9 | — | 0.02 | 0.005 | — | — | — | — | — | |
| 10 | 0.02 | — | — | — | — | — | — | — | |
| 11 | — | 0.02 | — | — | — | — | 0.02 | — | |
| 12 | — | — | — | — | — | — | — | 0.02 | |
| 13 | — | — | — | — | — | — | — | — | |
| 14 | — | — | — | — | — | — | — | — | |
| 15 | 0.16 | — | — | — | — | — | — | — | |
| 16 | — | — | 0.020 | — | — | — | — | — | |
| 17 | — | — | — | 0.0009 | — | — | — | — | |
| 18 | — | 0.14 | — | — | — | — | — | — | |
| 19 | — | — | — | — | — | — | — | — | |
| 20 | — | — | — | — | 0.0011 | — | — | — | |
| 21 | 0.09 | — | — | — | — | — | — | — | |
| 22 | — | — | — | — | — | — | — | — | |
| 23 | 0.61 | — | — | — | — | — | — | — | |
| 24 | — | 0.73 | — | — | — | 0.0009 | — | — | |
| 25 | — | — | 0.230 | — | — | — | — | — | |
| 26 | 0.07 | — | — | 0.0570 | — | — | — | — | |
| 27 | — | — | — | — | 0.0340 | — | 0.050 | — | |
| 28 | — | — | — | — | — | 0.0321 | — | 0.020 | |
| 29 | — | — | — | — | — | — | 0.440 | — | |
| 30 | — | — | 0.012 | — | — | — | — | 0.520 | |
| 31 | — | 0.02 | — | — | — | — | — | — | |
| 32 | — | — | — | — | 0.0013 | — | — | — | |
| 33 | 0.03 | — | — | — | — | 0.0012 | — | — | |
| 34 | — | 0.03 | — | — | — | — | — | — | |
| 35 | — | — | — | 0.0011 | — | — | — | — | Annealed |
| 36 | — | — | — | — | 0.0008 | — | — | — | Annealed |

Unit: mass %
Underlines indicate outside the scope of the present disclosure.

### Distribution Form of Precipitates

Each of the obtained steel bars (soft magnetic irons) was cut to prepare a cross-sectional sample with a circular cross section, and the cross-sectional sample was mirror polished to obtain a sample for observing the distribution form of precipitates. Any region of 0.2 mm² or more near the surface layer of the sample where decarburization and oxidation reactions had not occurred was observed using a scanning electron microscope (SEM) with an accelerating voltage of 15 kV and 10000 magnification. For the parts determined to be precipitates in the observed SEM image, the components constituting the precipitates were identified by analysis using an energy-dispersive X-ray spectrometer (EDS). The number density per unit area (/mm²) of the precipitates of MnS, BN, and their composite compound (MnS+BN) identified by the EDS analysis was measured.

In addition, the area of each of the identified precipitates was analyzed in the SEM image, and the equivalent circular diameter was calculated from the area. After this, the frequency distribution (histogram) of the calculated equivalent circular diameters was created with a class interval of 50 nm, and the mode and the proportion of precipitates of 600 nm or more in equivalent circular diameter were determined.

The results are shown in Table 2.

Moreover, for each of the obtained soft magnetic irons, the magnetic properties (magnetic flux density and coercive force), cold workability (critical upset ratio), and machinability by cutting (flank wear) were evaluated by the following methods.

### Magnetic Properties

The magnetic properties were measured in accordance with JIS C 2504. In detail, a ring-shaped test piece was collected from the steel bar (soft magnetic iron), and subjected to magnetic annealing of holding at 750° C. for 2 hours. After this, an excitation winding (primary winding: 220 turns) and a detection winding (secondary winding: 100 turns) were made around the ring-shaped test piece for testing. The magnetic flux density was determined by measuring the B-H curve using a DC magnetizing measurement device. Specifically, the respective magnetic flux densities at 100 A/m and 300 A/m in a magnetization process with a peak magnetic field of 10,000 A/m were determined. The results are shown in Table 2. The magnetic properties were regarded as excellent if the magnetic flux density at 100 A/m was 1.25 T or more and the magnetic flux density at 300 A/m was 1.55 T or more.

Using the same ring-shaped test piece having the windings as above, the coercive force was measured with a reversal magnetization force of ±400 A/m using a DC magnetic property tester. The results are shown in Table 2. The magnetic properties were regarded as excellent if the coercive force was 60 A/m or less.

### Cold Workability

The cold workability was evaluated based on the critical upset ratio.

In detail, a test piece of 15 mm in diameter and 22.5 mm in height and having a notch with a depth of 0.8 mm and a notch bottom radius R 0.15 on its side surface was collected from the depth position corresponding to ½ of the diameter from the peripheral surface of the steel bar. The test piece was subjected to compression forming. Compression was successively performed until a crack with a width of 0.5 mm or more occurred at the notch bottom of the test piece. The upset ratio at the time was taken to be the critical upset ratio. The results are shown in Table 2.

The cold workability was regarded as excellent if the critical upset ratio was 55% or more.

### Machinability by Cutting

The machinability by cutting was evaluated by measuring the flank wear of the tool. In detail, using a NC lathe, the steel bar of 25 mm in diameter was subjected to cutting work with a cut depth of 0.2 mm, a feed rate of 0.15 mm/rev, a peripheral speed of 300 m/min, wet type, and a length of cut of 1000 mm by a coated cemented carbide tool. After this, the flank wear of the tool was measured to evaluate the machinability by cutting. The results are shown in Table 2.

The machinability by cutting was regarded as excellent if the flank wear was 35 μm or less.

TABLE 2

| | Distribution form of precipitates | | | Magnetic properties | | | Cold | | |
|---|---|---|---|---|---|---|---|---|---|
| | | | Number proportion | Magnetic | Magnetic | | workability | Machinability | |
| Steel | Number | Mode of | of precipitates | flux density | flux density | Coercive | Critical | by cutting | |
| sample | density | distribution | of 600 nm or more | at 100 A/m | at 300 A/m | force | upset ratio | Flank wear | |
| No. | (/mm²) | (nm) | (%) | (T) | (T) | (A/m) | (%) | (μm) | Remarks |
| 1 | 8,500 | 200 | 16.4 | 1.275 | 1.574 | 49.5 | 65.2 | 20.1 | Example |
| 2 | 6,300 | 180 | 12.3 | 1.288 | 1.591 | 48.1 | 60.2 | 28.9 | Example |
| 3 | 7,200 | 160 | 17.1 | 1.281 | 1.577 | 45.1 | 64.2 | 21.8 | Example |
| 4 | 6,300 | 180 | 14.8 | 1.273 | 1.585 | 46.9 | 63.9 | 25.7 | Example |
| 5 | 5,400 | 230 | 9.8 | 1.279 | 1.573 | 52.2 | 57.7 | 27.2 | Example |
| 6 | 5,300 | 180 | 11.7 | 1.286 | 1.570 | 47.4 | 60.9 | 29.4 | Example |
| 7 | 5,300 | 150 | 14.9 | 1.279 | 1.582 | 45.5 | 60.0 | 25.5 | Example |
| 8 | 5,200 | 150 | 13.5 | 1.268 | 1.587 | 44.9 | 58.6 | 26.4 | Example |
| 9 | 8,300 | 190 | 16.6 | 1.284 | 1.559 | 47.7 | 62.8 | 21.7 | Example |
| 10 | 7,300 | 210 | 16.9 | 1.283 | 1.596 | 51.5 | 61.2 | 20.8 | Example |
| 11 | 6,800 | 170 | 10.1 | 1.269 | 1.571 | 48.0 | 56.5 | 22.3 | Example |
| 12 | 5,700 | 220 | 10.7 | 1.274 | 1.582 | 53.9 | 55.3 | 29.3 | Example |
| 13 | 4,800 | 410 | 7.1 | 1.129 | 1.443 | 81.8 | 63.4 | 29.1 | Comparative Example |
| 14 | 3,500 | 220 | 3.6 | 1.284 | 1.610 | 54.6 | 49.7 | 33.9 | Comparative Example |
| 15 | 6,900 | 380 | 7.7 | 1.288 | 1.590 | 73.7 | 56.8 | 20.2 | Comparative Example |
| 16 | 5,800 | 170 | 1.1 | 1.270 | 1.572 | 46.2 | 44.1 | 24.7 | Comparative Example |
| 17 | 5,700 | 280 | 1.4 | 1.239 | 1.534 | 56.3 | 42.8 | 24.9 | Comparative Example |
| 18 | 6,300 | 290 | 7.2 | 1.120 | 1.391 | 54.5 | 63.4 | 22.1 | Comparative Example |
| 19 | 6,300 | 470 | 5.1 | 1.139 | 1.418 | 72.9 | 47.5 | 22.7 | Comparative Example |
| 20 | 5,700 | 530 | 2.6 | 1.243 | 1.563 | 81.0 | 47.4 | 26.5 | Comparative Example |
| 21 | 4,900 | 280 | 6.4 | 1.180 | 1.448 | 51.0 | 57.4 | 28.5 | Comparative Example |
| 22 | 5,300 | 490 | 13.1 | 1.116 | 1.402 | 76.8 | 66.4 | 27.0 | Comparative Example |
| 23 | 5,700 | 410 | 12.3 | 1.103 | 1.399 | 71.3 | 58.9 | 26.3 | Comparative Example |
| 24 | 5,100 | 440 | 9.1 | 1.166 | 1.477 | 73.4 | 62.8 | 27.1 | Comparative Example |
| 25 | 4,900 | 490 | 4.1 | 1.145 | 1.476 | 76.3 | 45.9 | 29.8 | Comparative Example |
| 26 | 6,100 | 520 | 8.8 | 1.132 | 1.439 | 79.9 | 49.5 | 23.7 | Comparative Example |
| 27 | 6,900 | 610 | 7.5 | 1.197 | 1.487 | 85.6 | 49.7 | 20.3 | Comparative Example |
| 28 | 5,700 | 500 | 9.1 | 1.195 | 1.489 | 78.9 | 50.2 | 25.4 | Comparative Example |
| 29 | 6,200 | 440 | 7.5 | 1.136 | 1.416 | 73.5 | 56.1 | 23.6 | Comparative Example |
| 30 | 5,100 | 410 | 7.8 | 1.183 | 1.423 | 72.2 | 55.8 | 27.6 | Comparative Example |
| 31 | 2,400 | 220 | 5.4 | 1.220 | 1.537 | 55.3 | 57.4 | 38.0 | Comparative Example |
| 32 | 2,200 | 200 | 5.7 | 1.231 | 1.539 | 54.8 | 59.9 | 38.9 | Comparative Example |
| 33 | 3,100 | 210 | 5.3 | 1.208 | 1.531 | 53.1 | 57.1 | 28.9 | Comparative Example |
| 34 | 4,400 | 230 | 6.3 | 1.211 | 1.539 | 56.1 | 59.5 | 27.8 | Comparative Example |
| 35 | 4,800 | 360 | 7.1 | 1.205 | 1.513 | 47.8 | 60.8 | 29.6 | Comparative Example |
| 36 | 4,700 | 150 | 3.2 | 1.211 | 1.502 | 44.9 | 58.2 | 27.1 | Comparative Example |

As can be seen from Tables 1 and 2, each steel material (soft magnetic iron) according to the present disclosure was excellent in cold workability and had both magnetic properties and machinability by cutting at a high level. On the other hand, each Comparative Example having a chemical composition outside the scope of the present disclosure and/or a distribution form of precipitates outside the scope of the present disclosure was unsatisfactory in magnetic properties, cold workability, and/or machinability by cutting.

1. A soft magnetic iron comprising a chemical composition containing, in mass %,
C: 0.02% or less,
Si: 0.05% or less,
Mn: 0.010% or more and 0.500% or less,
P: 0.002% or more and 0.020% or less,
S: 0.001% or more and 0.050% or less,
Al: 0.010% or more and 0.050% or less,
O: 0.0010% or more and 0.0200% or less,
N: 0.0010% or more and 0.0100% or less, and
B: 0.0003% or more and 0.0065% or less,
with a balance consisting of iron and inevitable impurities,
wherein a total number density of precipitates of manganese sulfide (MnS), boron nitride (BN), and a composite compound thereof (MnS+BN) is 5,000/mm² or more, and
in a frequency distribution of equivalent circular diameters of the precipitates observed in a region of 0.2 mm² or more, a mode is 50 nm or more and 250 nm or less and a proportion of precipitates of 600 nm or more in equivalent circular diameter is 7% or more.

2. The soft magnetic iron according to claim 1, wherein the chemical composition further contains, in mass %, one or more selected from
Cu: 0.20% or less,
Ni: 0.30% or less, and
Cr: 0.30% or less.

3. The soft magnetic iron according to claim 1, wherein the chemical composition further contains, in mass %, one or more selected from
Mo: 0.10% or less,
V: 0.02% or less,
Nb: 0.015% or less, and
Ti: 0.010% or less.

4. The soft magnetic iron according to claim 1, wherein the chemical composition further contains, in mass %, one or two selected from
Sn: 0.10% or less, and
Sb: 0.10% or less.

5. The soft magnetic iron according to claim 3, wherein the chemical composition further contains, in mass %, one or two selected from
Sn: 0.10% or less, and
Sb: 0.10% or less.

6. The soft magnetic iron according to claim 2, wherein the chemical composition further contains, in mass %, one or more selected from
Mo: 0.10% or less,
V: 0.02% or less,
Nb: 0.015% or less, and
Ti: 0.010% or less.

7. The soft magnetic iron according to claim 2, wherein the chemical composition further contains, in mass %, one or two selected from
Sn: 0.10% or less, and
Sb: 0.10% or less.
